(19) United States
(12) Patent Application Publication
(10) Pub. No.: US 2022/0069525 A1
(43) Pub. Date: Mar. 3, 2022

(54) ELECTRIC-PORT SECURITY DEVICE

(71) Applicant: ELECTRONIC STOCK LTD., Petah Tikva (IL)

(72) Inventors: Boaz FRIDMAN, Petah Tikva (IL); Benny FRIDMAN, Petah Tikva (IL)

(21) Appl. No.: 17/421,519

(22) PCT Filed: Jan. 15, 2020
(86) PCT No.: PCT/IL2020/050065

§ 371 Date: Jul. 8, 2021

Related U.S. Application Data
(60) Provisional application No. 62/792,521, filed on Jan. 15, 2019.

(51) Int. Cl. H01R 13/639; G06F 21/85; H01R 24/28

(52) U.S. Cl. CPC H01R 13/639; H01R 24/28; G06F 21/85

(57) ABSTRACT

The present invention provides devices and methods for enhancing security of computer-based devices by physically blocking unused connection ports therein.

### FIELD OF THE INVENTION

The present invention relates to devices and methods for enhancing security of computer-based devices by physically blocking unused connection ports therein with a self-locking device.

### BACKGROUND

Today, most electronic devices are equipped with at least one connection port for various uses, such as for charging, electronically connecting two or more devices, data transfer, etc. Examples of known connection ports are (i) the universal serial bus (USB) port that provides a serial bus standard for connecting numerous devices to computers; (ii) type-C port; (iii) micro AB; (iv) micro B, (v) RJ45, (vi) HDMI, etc.

Most modern computers include at least one, and usually a plurality of USB ports (or any other connection port) that are used to connect peripherals such as a mouse, keyboard, scanner, digital camera, printer, external storage, etc. However, anyone with physical access to a computer's USB port (or any other connection port) can plug a portable flash drive or other mass storage device into the port and attempt to download information from the computer or upload malware, both pose a security problem.

In order to prevent easy access to such connection ports, various developments were made. For instance, US 2008/0041125 provides a mechanical lock for USB ports; and WO 2013/042108 discloses a security plug for preventing access to a USB socket adapted to complete an electrical circuit when inserted into the USB socket such that its removal from the USB socket breaks the circuit and is detected by a host computer.

It is also possible to acquire a mechanical lock for a USB port from Kensington (https://www.kensington.com/p/products/security/usb-port-locks/USB-Port-Blocker/).

However, all known mechanical locks for connection ports suffer from various disadvantages, such as the need for special keys to insert them and the possibility of easily removing them after installation using the same key.

Alternative methods for blocking access to connection ports is to use a security software that locks and manages the USB ports. However, such a software may be easily bypassed using malware.

Accordingly, a need exists for a simple device that can be irreversibly inserted into connection ports while preventing extraction thereof.

### SUMMARY

The present invention provides a connection port self-locking plug 100 comprising a main body 101 shaped and sized to fit into a connection port of a computing apparatus, wherein the main body 101 having a distal-end and a proximal-end, wherein the plug 100 is an irreversible/permanent self-locking plug that after insertion of the main body 101 into the connection port remains irreversibly/permanently inside the connection port, thereby irreversibly/permanently locking the port and preventing usage thereof.

In a specific aspect, the connection port self-locking plug 100 further comprises an insertion handle 102 removably attached to the proximal-end of the main body 101 such that after insertion of the main body 101 into the connection port, the insertion handle 102 is to be removed therefrom, leaving the main body 101 within the connection port, thereby irreversibly/permanently locking the port and preventing usage thereof.

In a further specific aspect, the connection port self-locking plug 100 further comprises a fixating compartment 104 within the main body 101 and comprising a fixating substance, wherein the fixating substance is designed to be released from the fixating compartment 104 and harden to irreversibly/permanently block access into the connection port to thereby lock the port and prevent usage thereof.

The present invention further provides a method of permanently locking a connection port of a device, the method comprising the steps of inserting the main body 101 of a plug 100 as defined above into the connection port thereby permanently leaving the main body 101 within the connection port, to permanently locking same and preventing future use.

In one aspect of the method of the invention for permanently locking a connection port of a device, the method comprising the steps of inserting the main body 101 of a plug 100 according to the invention into the connection port and releasing the fixating substance therein thereby permanently leaving the main body 101 within the connection port, to permanently locking same and preventing future use.

In another alternative aspect of the method of the invention for permanently locking a connection port of a device, the method comprising the steps of attaching the main body 101 of a plug 100 according to the invention to the opening of the connection port and releasing the fixating substance into the connection port thereby permanently locking same and preventing future use.

### BRIEF DESCRIPTION OF THE DRAWINGS

FIGS. 1A-1C illustrate an exemplary port-blocking device according to one embodiment of the invention.

FIGS. 2A-2C illustrate how an exemplary port-blocking device according to one embodiment of the invention blocks a computer port.

FIGS. 3A-3B illustrate an exemplary port-blocking device according to one embodiment of the invention comprising a double-chambered fixating compartment.

FIGS. 4A-4B illustrate another exemplary port-blocking device according to one embodiment of the invention comprising a single-chambered fixating compartment, with multiple exits.

FIGS. 5A-5C illustrate other exemplary port-blocking devices according to some embodiments of the invention comprising a single-chambered fixating compartment.

FIGS. 6A-6C illustrate exemplary C-type port-blocking devices according to some embodiments of the invention: FIG. 6A illustrates a plug without an insertion handle; FIG. 6B illustrates a plug with an insertion handle; and FIG. 6C illustrates a plug inside a C-type connection port (after removal of the insertion handle.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” or “another embodiment” means that a particular feature, structure, or characteristic described in conjunction with the embodiment can be included in at least one embodiment of the invention. Not all appearances of the phrase “in one embodiment” in various places in the specification necessarily refer to the same embodiment.

Today, electronic devices with connection ports therein are well known, constitute a growing market and can be found anywhere. This increases the risk of malicious use, such as implementing malware or stealing data in sensitive facilities (such as large companies or military), by accessing/infiltrating the electronic devices via their connection ports. Thus, it is essential to provide ways to prevent unauthorized access to such electronic devices via their connection ports. The present invention provides such a way.

Accordingly, in a first aspect, the present invention provides a connection port self-locking plug 100 comprising a main body 101 shaped and sized to fit into a connection port of a computing apparatus, wherein the main body 101 having a distal-end and a proximal-end, wherein the plug 100 is an irreversible/permanent self-locking plug that after insertion of the main body 101 into the connection port remains irreversibly/permanently inside the connection port, thereby irreversibly/permanently locking the port and preventing usage thereof.

In specific embodiments, the self-locking plug 100 of the invention further comprises an insertion handle 102 removably attached to the proximal-end of the main body 101 such that after insertion of the main body 101 into the connection port, the insertion handle 102 is to be removed therefrom, leaving the main body 101 within the connection port, thereby irreversibly/permanently locking the port and preventing usage thereof.

In alternative or additional specific embodiments of the self-locking plug 100 of any of the embodiments above, the main body 101 further comprises at least one protrusion 103 (locking tooth), e.g., at its proximal-end, such that after insertion of the main body 101 into the connection port, the at least one protrusion 103 interlocks, e.g. with groove(s), within the connection port and prevents removal thereof, thereby irreversibly/permanently locking the port and preventing usage thereof In specific embodiments thereof, pulling of the self-locking plug 100 out of the connection port is prevented by the at least one protrusion 103, and such a pulling may further destroy the connection port and prevent future use.

In specific embodiments, the present invention provides a connection port self-locking plug 100 comprising: (i) a main body 101 shaped and sized to fit and to be inserted into a connection port of a computing apparatus, wherein the main body 101 having a distal-end and a proximal-end, and comprises at least one protrusion 103 (locking tooth) at its proximal-end; and (ii) an insertion handle 102 removably attached to the proximal-end of the main body 101, wherein: the plug 100 is an irreversible/permanent self-locking plug; and after insertion of the main body 101 into the connection port (and interlocking the at least one protrusion 103 therein), the insertion handle 102 is to be removed therefrom, leaving the main body 101 within the connection port, thereby irreversibly/permanently locking the port and preventing usage thereof.

The term “connection port” as used herein throughout the application refers to any port, in any size and shape, that is used to connect a computing apparatus to, e.g., electricity, another computing apparatus, charger, exterior device/apparatus, etc. Non-limiting examples of such connection ports include universal serial bus (USB) port, type-C port; micro AB; micro B, RJ45; HDMI, etc.

In a second aspect, the present invention provides a connection port self-locking plug 100 comprising a main body 101 shaped and sized to fit a connection port of a computing apparatus, wherein the main body 101 having a distal-end and a proximal-end, and a fixating compartment 104 within the main body 101 and comprising a fixating substance, wherein the plug 100 is an irreversible/permanent self-locking plug that after release of the fixating substance into the connection port and hardening thereof, irreversibly/permanently locks the port and prevents usage thereof. In specific embodiments, the main body 101 is not designed to be inserted into the connection port, but rather is designed to be attached to the connection port's opening, and the fixating substance is then injected into the connection port—without inserting the self-locking plug 100 into the connection port. In alternative specific embodiments, the main body 101 is inserted into the connection port, but after releasing the fixating substance in the connection port the self-locking plug 100 is removed from the connection port leaving behind only the fixating substance. In alternative specific embodiments, the main body 101 is inserted into the connection port and remains inside after releasing of the fixating substance.

It should be noted that the releasing of the fixating substance from the fixating compartment 104 within the main body 101 can be done in any suitable way, such as applying pressure directly on the main body 101, pressing a release button, using a stick to puncture a hole at an exit point(s) of the fixating substance, puncturing a barrier while inserting the plug 100 in to the connection port due to the presence of a protrusion within the port (e.g. as in the case of a C-type port and a USB), etc.

In specific embodiments, the above self-locking plug 100 further comprises an insertion handle 102 removably attached to the proximal-end of the main body 101, wherein: after insertion of the main body 101 into the connection port, the insertion handle 102 is to be removed therefrom, thereby (a) leaving the main body 101 within the connection port; and (b) releasing the fixating substance from the fixating compartment 104; and the released fixating substance hardens to irreversibly/permanently maintain the main body 101 within the connection port to thereby lock the port and prevent usage thereof.

In alternative or additional embodiments, the main body 101 further comprises at least one protrusion 103 (locking tooth) at its proximal-end, such that after insertion of the main body 101 into the connection port, the at least one protrusion 103 interlocks, e.g., with dedicated grooves, within the connection port and prevents removal thereof, thereby irreversibly/permanently locking the port and preventing usage thereof In further specific embodiments, pulling of the self-locking plug 100 out of the connection port is prevented by both the at least one protrusion 103 and the released and hardened fixating substance, and such a pulling attempt may further destroy the connection port.

The term “fixating substance” as used herein throughout the application refers to any substance that upon its release hardens and assists in locking a connection port, e.g. by preventing removal of a plug therefrom and/or by creating a physical hard barrier that prevents usage of the connection port. In specific embodiments, the fixating substance is based on a two-component mixture that their mixing results with a hardened material, such as epoxy resins, and epoxy resin and hardener/curative. In alternative embodiments, the fixating substance is a self-expandable substance that once exposed to air expands and hardens, such as polyurethane. In specific embodiments, the fixating substance hardens when exposed to air.

In specific embodiments, the present invention provides a connection port self-locking plug 100 comprising: (i) a main body 101 shaped and sized to be inserted into a connection port of a computing apparatus, wherein the main body 101 having a distal-end and a proximal-end; (ii) an insertion handle 102 removably attached to the proximal-end of the main body 101; and (iii) a fixating compartment 104 comprising a fixating substance, wherein: the plug 100 is an irreversible/permanent self-locking plug; after insertion of the main body 101 into the connection port, the insertion handle 102 is to be removed therefrom, thereby (a) leaving the main body 101 within the connection port; and (b) releasing the fixating substance from the fixating compartment 104; and the released fixating substance hardens to irreversibly/permanently maintain the main body 101 within the connection port to thereby lock the port and prevent usage thereof.

In a specific aspect, the present invention provides a connection port self-locking plug 100 that comprises: (i) a main body 101 shaped and sized to be inserted into a connection port of a computing apparatus, wherein the main body 101 having a distal-end and a proximal-end, and comprises at least one protrusion 103 (locking tooth) at its proximal-end; (ii) an insertion handle 102 removably attached to the proximal-end of the main body 101; and (iii) a fixating compartment 104 comprising a fixating substance, wherein: the plug 100 is an irreversible/permanent self-locking plug; after insertion of the main body 101 into the connection port and interlocking the at least one protrusion 103 therein, the insertion handle 102 is to be removed therefrom, thereby (a) leaving the main body 101 within the connection port; and (b) releasing the fixating substance from the fixating compartment 104; and the released fixating substance hardens and together with the protrusion 103 irreversibly/permanently maintain the main body 101 within the connection port, lock it, and prevent usage thereof.

In certain embodiments of the plug 100 of the invention according to any of the embodiments herein, the fixating compartment 104 comprises one, two or more chambers holding the same or different fixating substances. In specific embodiments, the fixating compartment 104 comprises a single chamber with a single fixating substance that upon release and exposure to air hardens (and optionally spreads before hardening). Non-limiting examples of such fixating substances are cyanoacrylates (also known as superglue), silicones (that hardens a bit slower than cyanoacrylates), and polyurethane.

In other specific embodiments, the fixating compartment 104 comprises two separate chambers, each with one component of a fixating substance that when mixed together form a hard glue. Non-limiting examples of such fixating substance is epoxy glue.

In certain embodiments, the fixating substance exits the main body 101 through a single exit, e.g. at the breaking point of the insertion handle 102 or at any point within the main body 101, e.g. at the upper or lower section of the main body 101. In alternative embodiments, the fixating substance exits the main body 101 through multiple exits, e.g. at the sides and the upper and/or lower section of the main body 101 and/or at the breaking point of the insertion handle 102, and/or at the distal end thereof, or any other possible combination. The location of the exit point(s) is determined according to the type, shape and size of the connection port, and is designed to enable optimal contact between the main body 101 and the connection port.

In specific embodiments of the self-locking plug 100 of the invention, the connection port is a USB port.

It should be noted that the term “computing apparatus” as used herein refers to any device/apparatus that has at least one connection port, such as a computer, a smartphone, a tablet, an electronic console, a game center/console, power tools, music instruments, etc.

The terms “protrusion” and “locking tooth” as used herein interchangeably refer to any construction that is designed to interlock with a dedicated area of a connection port to prevent extraction of the self-locking plug 100 of the invention once inserted into the connection port. The shape, size and number of the protrusion are determined according to the specific connection port that needs to be blocked, and can be one, two, three, four or more protrusions. In specific embodiments, the protrusion is actually a groove designed to interlock with a protrusion that is part of the connection port.

Accordingly, in certain embodiments of the self-locking plug 100 of any of the embodiments above, the at least one protrusion 103 is sized and shaped to be locked inside the connection port.

In specific embodiments of the self-locking plug 100 of any of the embodiments above, the at least one protrusion 103 is a fixed protrusion. In alternative embodiments, the at least one protrusion 103 is a spring-like protrusion. In yet other alternative embodiments, a single self-locking plug 100 comprises at least one protrusion 103 that is a spring-like protrusion and at least one protrusion 103 that is a fixed protrusion.

In specific alternative embodiments of the self-locking plug 100 of the invention, the at least one protrusion 103 is positioned internally (hidden) in the plug 100 during storage and is extracted only after insertion of the main body 101 into the connection port and the breakage of the insertion handle 102. This enables to verify that the plug 100 is positioned accurately in the connection plug prior to permanently locking the port.

In certain embodiments, the self-locking plug 100 of any of the embodiments above comprises one, two, three, four or more protrusions.

In specific embodiments, the self-locking plug 100 of any of the embodiments above is designed to be inserted in an irreversible manner into a connection port and resides therein permanently. Accordingly, in certain embodiments, pulling of the self-locking plug 100 of any of the embodiments above, out of a connection port after its insertion, is prevented, e.g., by the at least one protrusion 103 or the fixating substance, or both, and such a pulling attempt may further destroy the connection port and prevent use thereof even if the plug 100 is to removed somehow. Destruction of the port is achieved, e.g., due to deformity of the connection port's structure and/or damaging of the inner electrical conduits, due to forces applied thereon during the pulling of the self-locking plug 100.

It should be noted that the self-locking plug 100 of any of the embodiments above can be designed to fit any desired connection port. Accordingly, in certain embodiments, the self-locking plug 100 of any of the embodiments above is designed to fit a connection port that is a USB port; a type-C port; a micro AB port; a micro B port; a RJ45 port ; or a HDMI port.

In alternative specific embodiments, the self-locking plug 100 of any of the embodiments above is designed to fit the opening of a connection port, so that a fixating substance can be inserted into the port and hardened to create an irreversible and permanent plug/barrier inside the connection port to permanently prevent use of the connection port.

In certain embodiments of the self-locking plug 100 of any of the embodiments above, the computing apparatus or device is a computer or any other electronic device with at least one connection port.

The self-locking plug 100 according to any of the embodiment above can be manufactured in any suitable manner, such as molding, blow-molding, 3D printing, etc., and can be fabricated from any suitable material, such as plastic, rubber, polycarbonate, metal, alloy, or any combination thereof. Accordingly, in certain embodiments, the self-locking plug 100 of any of the embodiments above is made of plastic, hard polymer or metal, or a combination thereof.

The present invention further provides methods for permanently locking a connection port of a device. In some embodiments, the method comprises the steps of inserting the main body 101 of a plug 100 according to any of the embodiments above into the connection port to be locked thereby permanently leaving the main body 101 within the connection port, to permanently locking same and preventing future use. In specific embodiments, when the plug 100 comprises a fixating substance, the method comprises the steps of inserting the main body 101 of a plug 100 according to any of the embodiments above into the connection port and releasing the fixating substance therein thereby permanently leaving the main body 101 within the connection port, to permanently locking same and preventing future use. In alternative embodiments when the plug 100 comprises a fixating substance, the method comprises the steps of attaching the main body 101 of the plug 100 according to any of the embodiments above to the opening of the connection port and releasing the fixating substance into the connection port (without inserting the plug 100 into the connection port) and letting the fixating substance to harden, thereby permanently locking same and preventing future use.

In specific embodiments of the method according to any of the embodiments above, the main body 101 is not inserted into the connection port. In alternative specific embodiments, the main body 101 is partially inserted. In further specific embodiments, the main body 101 is removed from the connection port after releasing the fixating substance leaving behind only the fixating substance.

It should be noted that the releasing of the fixating substance from the main body 101 can be done in any suitable way, such as applying pressure directly on the main body 101, pressing a release button, breaking or twisting the insertion handle 102 (when present), using a stick to puncture a hole at an exit point for the fixating substance, using an integral part of the connection port for puncturing a seal within the plug 100 during its insertion into the connection port to thereby release the fixating substance (as present in a USB or C-type port), etc.

In specific embodiments of the method of the invention of permanently locking a connection port of a device, the method comprises the steps of: (a) inserting the main body 101 of a plug 100 that comprises insertion handle 102 and at least one protrusion 103 on the main body 101 into the connection port until the at least one protrusion 103 interlocks inside the port; and (b) breaking/twisting the insertion handle 102 from the main body 101, thereby permanently leaving the main body 101 within the connection port, to permanently locking same and preventing future use.

In specific embodiments of the method of the invention, when the plug 100 comprises the at least one protrusion 103, step (a) of inserting the main body 101 of the plug 100 into the connection port is carried out until the at least one protrusion 103 interlocks inside the port. In alternative specific embodiments, when the protrusion 103 is hidden within the plug 100, step (b) of breaking/twisting the insertion handle 102 (when present) from the main body 101 causes the extraction of the at least one protrusion 103, which can then interlock with the connection port. In yet further alternative specific embodiments, when the plug 100 comprises a fixation compartment 104, step (b) of breaking the insertion handle 102 (when present) from the main body 101 causes the release of the fixation substance which fixate the body 101 within the connection port. Notably, if there is no insertion handle 102, the release of the fixation substance can be done by any other suitable manner, such as by squeezing the main body 101, puncturing a seal using an external device, etc.

In specific embodiments of the method according to any of the embodiments above, when the plug 100 does not comprise a fixation compartment 104 with a fixating substrate, the method further includes a step of inserting or releasing a fixation substance from an external capsule or container into the connection port (before, after or during insertion of the main body 101), thereby fixating the main body 101 to the connection port in an irreversible manner.

In specific embodiments of the method according to any of the embodiments above, when the plug 100 includes an insertion handle 102 and a fixation substance compartment 104, the method comprises the steps of: (a) inserting the main body 101 of a plug 100 into the connection port; and (b) breaking the insertion handle 102 from the main body 101, and releasing the fixating substance from the fixating compartment 104, thereby permanently leaving the main body 101 within the connection port, to permanently locking same and preventing future use. In further specific embodiments, when the plug 100 further includes at least one protrusion 103, the method comprises the steps of: (a) inserting the main body 101 into the connection port until the at least one protrusion 103 interlocks inside; (b) breaking the insertion handle 102, when present, from the main body 101; and (c) releasing the fixating substance from the fixating compartment 104, thereby permanently leaving the main body 101 within the connection port, to permanently locking same and preventing future use. The releasing of the fixating substance from the fixating compartment 104 may by due to the breaking of the insertion handle 102, or due to any other action taken by the user, such as squeezing the main body 101, puncturing a seal (before, after or during insertion of the plug 100 into the connection port), etc.

In certain embodiments, the above methods are used for protecting one or all connection ports of a computing apparatus. In a specific embodiment, the different steps of any one of the methods described herein are repeated for all connection ports of the device/computing apparatus, each time with a new plug 100 in accordance with the port's type.

The invention will now be fully described by reference to the accompanying drawings. It should be noted that although the drawings illustrate mainly a rectangular plug 100 suitable, e.g., for a USB connection port, they are not intended to be limiting solely thereto.

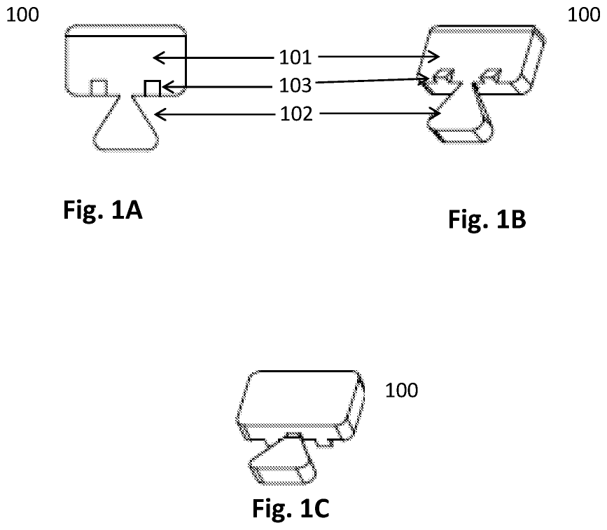

Referring now to the drawings, FIGS. 1A-1C illustrate one possible configuration of a port-blocking plug 100 according to one embodiment of the invention. FIG. 1A is a lower view and FIG. 1B is a 3-dimentional lower view, both showing two protrusions 103 located at the lower section of the plug 100. It should be noted that the location of the protrusions 103 may vary and can be at the lower- and/or upper sections of the plug 100, and/or at the plug's surroundings. In specific embodiment, the plug 100 comprises at least one protrusion 103 at its lower section, and at least one protrusion 103 at its upper section. FIG. 1C is a 3-dimentional upper view of the plug 100 of FIGS. 1A and 1B.

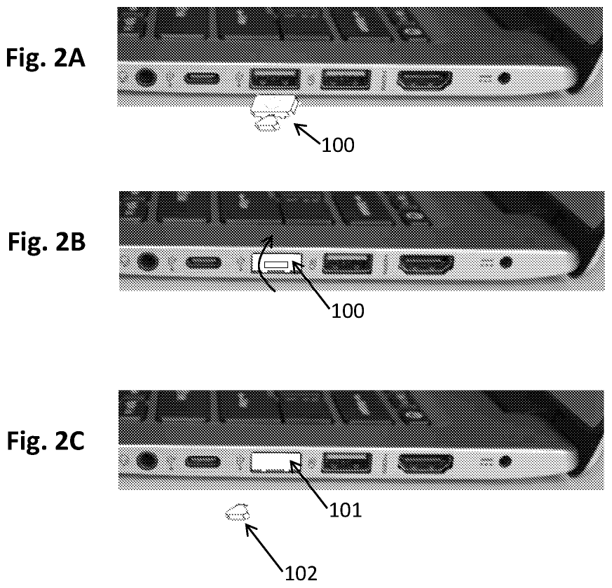

FIGS. 2A-2C illustrate how a USB port-blocking plug 100 according to one embodiment of the invention blocks a computer's USB port: FIG. 2A illustrates how the plug 100 is inserted into the USB port; FIG. 2B illustrates how the insertion handle 102 is removed from the plug 100 after insertion of the plug 100 into the USB port—the removing is by simply lifting, lowering or twisting the insertion handle 102 to break it off the main body 101; and FIG. 2C illustrates how the main body 101 remains in the a permanent manner inside the USB port after the removal of the insertion handle 102.

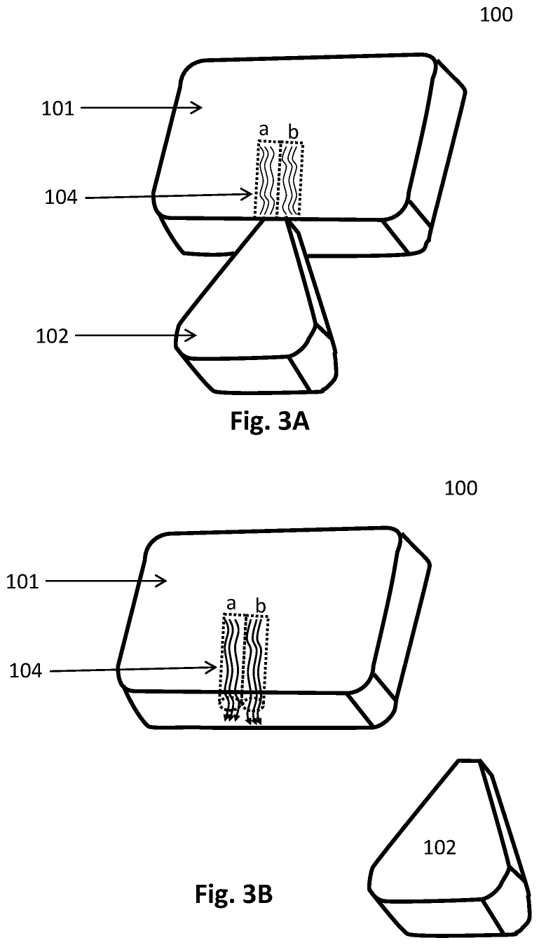

FIGS. 3A-3B illustrate another possible configuration of a port-blocking plug 100 according to one embodiment of the invention. FIG. 3A is a 3-dimentional view showing an internal double-chambered fixating compartment 104, wherein in each chamber there is one part of a fixating substance. FIG. 3B illustrates that when breaking off the insertion handle 102, both fixating substances (a and b) are released from the main body 101 at the breaking point. The mixing of the two fixating substances (a and b) forms a hardened adhesive (glue) between the body 101 and the connection port, to thereby prevent extraction of the main body 101 from the connection port.

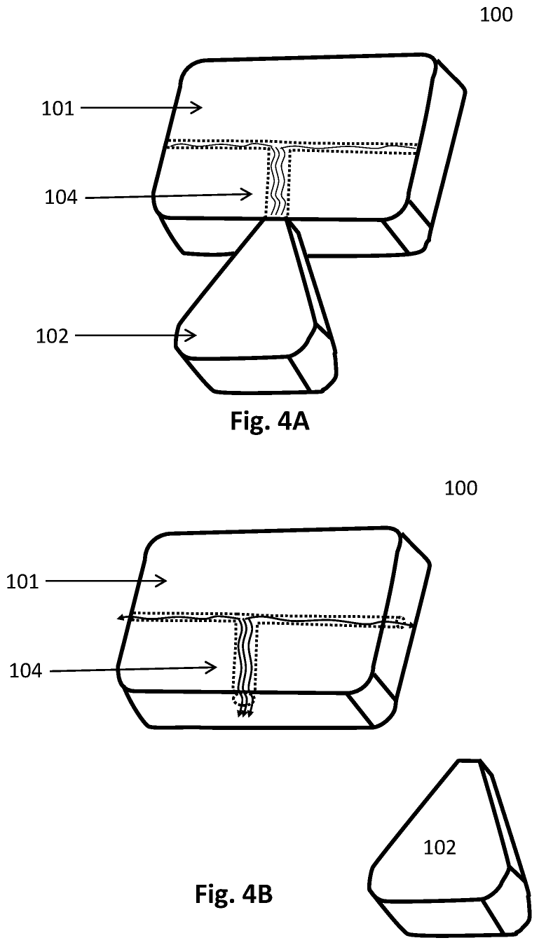

FIGS. 4A-4B illustrate yet another possible configuration of a port-blocking plug 100 according to one embodiment of the invention. FIG. 4A is a 3-dimentional view showing an internal single-chambered fixating compartment 104 having three possible exits: one on each side of the main body 101 and one at the breaking point between the body 101 and the insertion handle 102. FIG. 3B illustrates that when breaking off the insertion handle 102, the fixating substance is released from the main body 101 via all three exits. The fixating substance hardens to thereby adhere/glue the body 101 to the connection port, to thereby prevent extraction of the main body 101 therefrom.

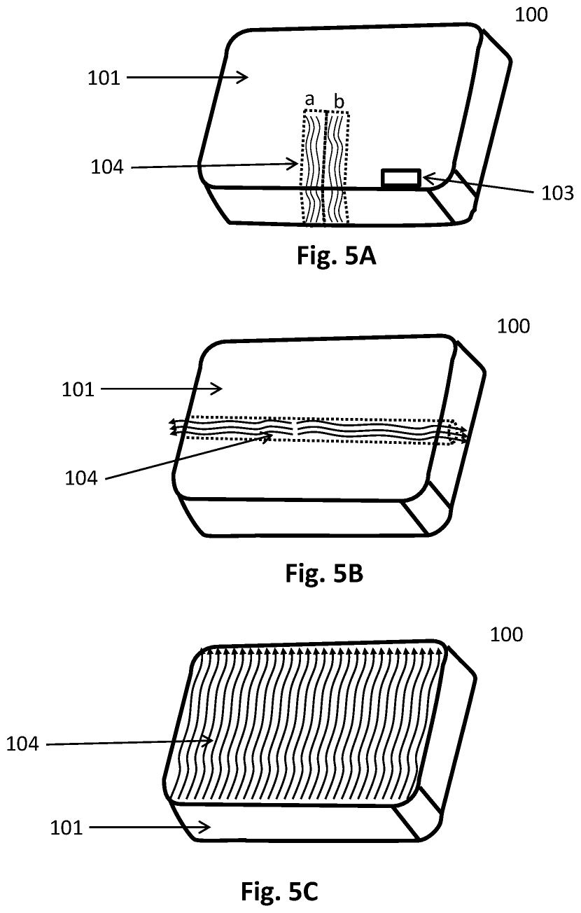

FIGS. 5A-5C illustrate other configurations of a port-blocking plug 100 according to some embodiments of the invention, in which the plug 100 does not have an insertion handle. As illustrated, the main body 101 may or may not be inserted into the connection port and may or may not be equipped with one or more protrusions 103. When the plug 100 is designed to be inserted into the connection port, the release of the fixating substance therefrom, may be done in any suitable way, such as by puncturing a seal with a protrusion already present within the connection port, such that the actual insertion breaks the seal and releases the fixating substance into the port. Alternatively, the user may press/squeeze the main body 101 to thereby force the fixating substance out of the fixation compartment 104 via designated exits located, e.g., at the sides of the main body (FIG. 5B), at the front of the main body, or at the rear side (facing outside) (FIG. 5A), or any combination thereof. Alternatively, the user may use an external puncturing or pressing element to release the fixating substance (before or after insertion of the plug 100 into the connection port). It should be noted that the release of the fixating substance may be either when the plug 100 is fully inserted in the connection port, or partially inserted, such that after the release of the fixating substance the main body 101 is fully pushed into the connection port (before the fixating substance hardens). Alternatively, the plug 100 may remain completely outside the connection port, such that after the release of the fixation substance, the empty plug is disposed of.

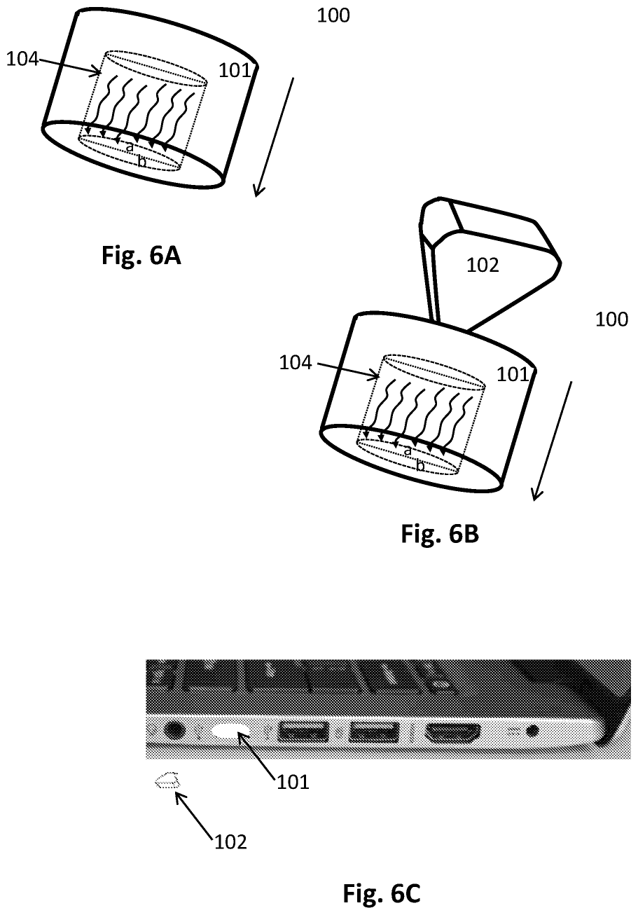

FIGS. 6A-6C illustrate specific configurations of a port-blocking plug 100 according to some embodiments of the invention for a c-type connection port, in which the plug 100 includes (FIG. 6B) or does not include an insertion handle (FIG. 6A). Notably, since a C-type connection port is smooth and does not have any areas for a protrusion to hold, the plug 100 for a c-type connection port is not equipped with such protrusions. As illustrated, when the plug 100 is inserted into the connection port, an inner protrusion within the connection port puncture a seal at the opening of the plug 100, leading to the release of the fixating substance therefrom into the port (FIG. 6A). Alternatively, the user may press/squeeze the main body 101 to thereby force the fixating substance out of the fixation compartment 104 via designated exits located, e.g., at the sides of the main body, at the front of the main body, or at the rear side (facing outside), or any combination thereof. Alternatively, the user may use an external puncturing or pressing element to release the fixating substance (before or after insertion of the plug 100 into the connection port). It should be noted that the release of the fixating substance may be either when the plug 100 is fully inserted in the connection port, or partially inserted, such that after the release of the fixating substance the main body 101 is fully pushed into the connection port (before the fixating substance hardens). Alternatively, the plug 100 may remain completely outside the connection port, such that after the release of the fixation substance, the empty plug is disposed of.

1. A connection port self-locking plug 100 comprising a main body 101 shaped and sized to fit into a connection port of a computing apparatus, wherein said main body 101 having a distal-end and a proximal-end,
wherein said plug 100 is an irreversible/permanent self-locking plug that after insertion of said main body 101 into said connection port remains irreversibly/permanently inside the connection port, thereby irreversibly/permanently locking the port and preventing usage thereof.

2. The connection port self-locking plug 100 of claim 1, further comprising an insertion handle 102 removably attached to the proximal-end of said main body 101 such that after insertion of said main body 101 into said connection port, said insertion handle 102 is to be removed therefrom, leaving the main body 101 within said connection port, thereby irreversibly/permanently locking the port and preventing usage thereof.

3. The connection port self-locking plug 100 of claim 1, wherein said main body 101 further comprises at least one protrusion 103, such that after insertion of said main body 101 into said connection port, said at least one protrusion 103 interlocks within said connection port and prevents removal thereof, thereby irreversibly/permanently locking the port and preventing usage thereof, wherein pulling of the self-locking plug 100 out of said connection port may further destroy said connection port.

4. (canceled)

5. The connection port self-locking plug 100 of claim 1, comprising:
(i) a main body 101 shaped and sized to fit into a connection port of a computing apparatus, wherein said main body 101 having a distal-end and a proximal-end, and comprises at least one protrusion 103; and
(ii) an insertion handle 102 removably attached to the proximal-end of said main body 101, wherein:
said plug 100 is an irreversible/permanent self-locking plug; and
after insertion of said main body 101 into said connection port (and interlocking said at least one protrusion 103 therein), said insertion handle 102 is to be removed therefrom, leaving the main body 101 within said connection port, thereby irreversibly/permanently locking the port and preventing usage thereof.

6. A connection port self-locking plug 100 according to claim 1, further comprising a fixating compartment 104 within said main body 101 and comprising a fixating substance, wherein said fixating substance is designed to be released from the fixating compartment 104 and harden to irreversibly/permanently block access into the connection port to thereby lock the port and prevent usage thereof.

7. The connection port self-locking plug 100 of claim 6, further comprising an insertion handle 102 removably attached to the proximal-end of said main body 101, wherein:
after insertion of said main body 101 into said connection port, said insertion handle 102 is to be removed therefrom, thereby (a) leaving the main body 101 within said connection port; and (b) releasing said fixating substance from the fixating compartment 104; and
the released fixating substance hardens to irreversibly/permanently maintain the main body 101 within the connection port to thereby lock the port and prevent usage thereof.

8. The connection port self-locking plug 100 of claim 6, wherein said main body 101 further comprises at least one protrusion 103, such that after insertion of said main body 101 into said connection port, said at least one protrusion 103 interlocks within said connection port and prevents removal thereof, thereby irreversibly/permanently locking the port and preventing usage thereof.

9. The self-locking plug 100 of claim 8, wherein pulling of the self-locking plug 100 out of said connection port is prevented by both said at least one protrusion 103 and said fixating substance, and such a pulling attempt may further destroy said connection port.

10. The connection port self-locking plug 100 of claim 6, wherein said fixating substance is two-component substances that their mixing results with a hardened material.

11. The connection port self-locking plug 100 of claim 6, wherein said fixating substance is a self-expandable substance that once exposed to air expands and hardens.

12. The connection port self-locking plug 100 of claim 6, wherein said fixating substance hardens when exposed to air.

13. A connection port self-locking plug 100 according to claim 6, comprising:
(i) a main body 101 shaped and sized to fit into a connection port of a computing apparatus, wherein said main body 101 having a distal-end and a proximal-end;
(ii) an insertion handle 102 removably attached to the proximal-end of said main body 101; and
(iii) a fixating compartment 104 comprising a fixating substance, wherein:
said plug 100 is an irreversible/permanent self-locking plug;
after insertion of said main body 101 into said connection port, said insertion handle 102 is to be removed therefrom, thereby (a) leaving the main body 101 within said connection port; and (b) releasing said fixating substance from the fixating compartment 104; and
the released fixating substance hardens to irreversibly/permanently maintain the main body 101 within the connection port to thereby lock the port and prevent usage thereof.

14. The self-locking plug 100 of claim 3, wherein said at least one protrusion 103 is a fixed protrusion or a spring-like protrusion.

15. The self-locking plug 100 of claim 3, wherein said at least one protrusion 103 is a fixed protrusion or a spring-like protrusion.

16. A method for permanently locking a connection port of a device, the method comprising the steps of inserting the main body 101 of a plug 100 according to claim 1 into said connection port thereby permanently leaving said main body 101 within said connection port, to permanently locking same and preventing future use.

17. The method of claim 16 for permanently locking a connection port of a device, the method comprising the steps of inserting the main body 101 of a plug 100 as defined in claim 6 into said connection port and releasing said fixating substance therein thereby permanently leaving said main body 101 within said connection port, to permanently locking same and preventing future use.

18. A method for permanently locking a connection port of a device, the method comprising the steps of attaching the main body 101 of a plug 100 according to claim 6 to the opening of said connection port and releasing said fixating substance into said connection port thereby permanently locking same and preventing future use.

19. A method of permanently locking a connection port of a device, the method comprising the steps of:
a) inserting the main body 101 of a plug 100 according to claim 3 into said connection port until said at least one protrusion 103 interlocks inside; and
b) breaking the insertion handle 102, when present, from said main body 101, thereby permanently leaving said main body 101 within said connection port, to permanently locking same and preventing future use.

20. A method for permanently locking a connection port of a device, the method comprising the steps of:
a) inserting the main body 101 of a plug 100 according to claim 7 into said connection port; and
b) breaking the insertion handle 102 from said main body 101, and releasing said fixating substance from said fixating compartment 104,
thereby permanently leaving said main body 101 within said connection port, to permanently locking same and preventing future use.

21. A method for permanently locking a connection port of a device, the method comprising the steps of:
a) inserting the main body 101 of a plug 100 according to claim 8 into said connection port until said at least one protrusion 103 interlocks inside;
b) breaking the insertion handle 102, when present, from said main body 101; and
c) releasing said fixating substance from said fixating compartment 104,
thereby permanently leaving said main body 101 within said connection port, to permanently locking same and preventing future use.
